(19) United States
(12) Patent Application Publication
(10) Pub. No.: US 2014/0132379 A1
(43) Pub. Date: May 15, 2014

(54) INTEGRATED INDUCTOR ASSEMBLY

(71) Applicant: FORD GLOBAL TECHNOLOGIES, LLC, Dearborn, MI (US)

(72) Inventors: Behzad Vafakhah, Ann Arbor, MI (US); Shailesh Shrikant Kozarekar, Novi, MI (US); Vincent Skalski, Plymouth, MI (US)

(73) Assignee: FORD GLOBAL TECHNOLOGIES, LLC, Dearborn, MI (US)

(21) Appl. No.: 13/673,748

(22) Filed: Nov. 9, 2012

(51) Int. Cl. H01F 27/12

(52) U.S. Cl. CPC H01F 27/12
USPC 336/57

(57) ABSTRACT

A vehicle is provided with a transmission that defines a chamber, and a coil that is mounted within the chamber. The coil defines a cavity. The vehicle also includes a core having at least two projections that are spaced radially outward of the coil and angularly spaced apart from each other to define openings therebetween. The core also includes first and second ends that are interconnected by a post that extends through the cavity.

### TECHNICAL FIELD

One or more embodiments relate to an inductor assembly of a DC-DC converter.

### BACKGROUND

The term “electric vehicle” as used herein, includes vehicles having an electric machine for vehicle propulsion, such as battery electric vehicles (BEV), hybrid electric vehicles (HEV), and plug-in hybrid electric vehicles (PHEV). A BEV includes an electric machine, wherein the energy source for the electric machine is a battery that is re-chargeable from an external electric grid. In a BEV, the battery is the source of energy for vehicle propulsion. A HEV includes an internal combustion engine and one or more electric machines, wherein the energy source for the engine is fuel and the energy source for the electric machine is a battery. In a HEV, the engine is the main source of energy for vehicle propulsion with the battery providing supplemental energy for vehicle propulsion (the battery buffers fuel energy and recovers kinematic energy in electric form). A PHEV is like a HEV, but the PHEV has a larger capacity battery that is rechargeable from the external electric grid. In a PHEV, the battery is the main source of energy for vehicle propulsion until the battery depletes to a low energy level, at which time the PHEV operates like a HEV for vehicle propulsion.

Electric vehicles may include a voltage converter (DC-DC converter) connected between the battery and the electric machine. Electric vehicles that have AC electric machines also include an inverter connected between the DC-DC converter and the electric machine. A voltage converter increases (“boosts”) or decreases (“bucks”) the voltage potential to facilitate torque capability optimization. The DC-DC converter includes an inductor (or reactor) assembly, switches and diodes. A typical inductor assembly includes a conductive coil that is wound around a magnetic core. The inductor assembly generates heat as current flows through the coil. An existing method for cooling the DC-DC converter by circulating fluid through a conduit that is proximate to the inductor is disclosed in U.S. 2004/0045749 to Jaura et al.

### SUMMARY

In one embodiment, a vehicle is provided with a transmission that defines a chamber and a coil that is mounted within the chamber. The coil defines a cavity. The vehicle also includes a core having at least two projections that are spaced radially outward of the coil and angularly spaced apart from each other to define openings therebetween. The core also includes first and second ends that are interconnected by a post that extends through the cavity.

In another embodiment, an integrated inductor assembly is provided a coil that defining a cavity and a core having a core with at least two projections spaced radially outward of the coil and interconnected by first and second ends. The projections are angularly spaced apart from each other to define openings between adjacent projections. The core also includes a post that extends through the cavity between the first and second ends. The core is formed as a unitary structure around the coil.

In yet another embodiment, a voltage converter is provided with a coil, a core and at least two switches. The coil defines a cavity and is mounted within a chamber of a transmission. The core has a post that extends through the cavity and at least two projections that are spaced radially outward of the coil and angularly spaced apart from each other to define openings. The switches are mounted external to the transmission and are in communication with the coil.

As such, the inductor assembly provides advantages over existing inductor assemblies by facilitating direct cooling of the conductor and core. Further the inductor assembly provides a simplified integrated structure without potting compound or additional housings and cold plates. Additionally, this integrated structure simplifies the mounting and packaging of the inductor assembly inside of the transmission and minimizes Electromagnetic Interference (EMI) and the leakage inductance by substantially surrounding the conductor with the magnetic core.

### BRIEF DESCRIPTION OF THE DRAWINGS

FIG. 1 is a front view of a transmission and a variable voltage converter (VVC) having an inductor assembly mounted within the transmission according to one or more embodiments;

FIG. 2 is a schematic diagram of a vehicle including the transmission and the VVC of FIG. 1;

FIG. 3 is a circuit diagram of the VVC of FIG. 1;

FIG. 4 is a section view of an inductor assembly according to another embodiment;

FIG. 5 is an exploded side perspective view of the inductor assembly of FIG. 1;

FIG. 6 is an enlarged side perspective view of a conductor and an insulator of the inductor assembly of FIG. 1;

FIG. 7 is a front perspective view of the inductor assembly of FIG. 1;

FIG. 8 is a section view of the inductor assembly of FIG. 7 taken along section line 8-8;

FIG. 9 is a front perspective view of the inductor assembly of FIG. 1, illustrating heat transfer;

FIG. 10 is a die for forming a magnetic core of the inductor assembly of FIG. 1; and

FIG. 11 is an exploded view illustrating a process for forming the inductor assembly of FIG. 1, using the die of FIG. 10.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

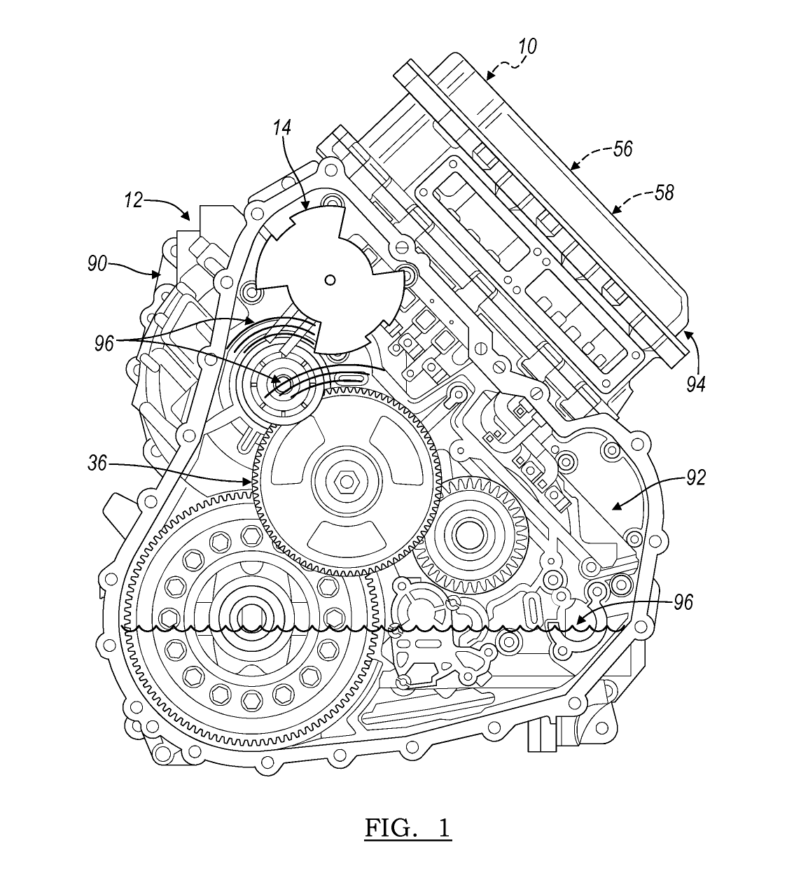

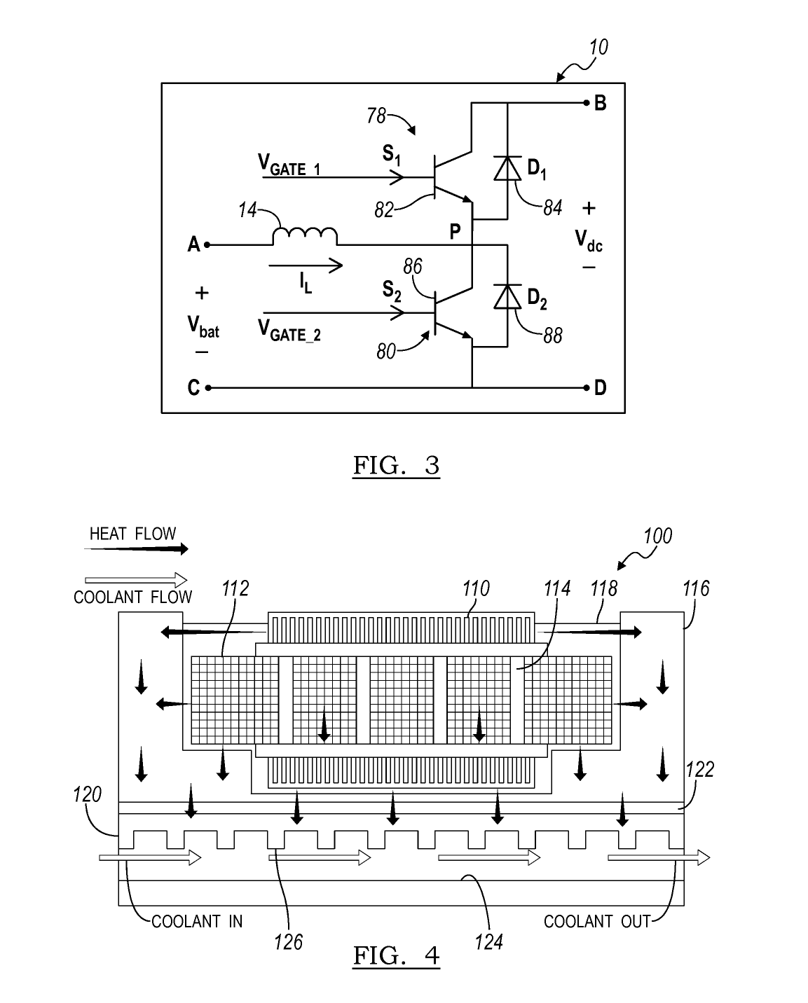

With reference to FIG. 1, a DC-DC converter is illustrated in accordance with one or more embodiments and is generally referenced by numeral 10. The DC-DC converter 10 may also be referred to as a variable voltage converter (VVC) 10. The VVC 10 is an assembly with components that are mounted both inside and outside of a transmission 12. The VVC 10 includes an inductor assembly 14 that is mounted inside of the transmission 12 and a number of switches and diodes (shown in FIG. 3) that are mounted outside of the transmission 12. By mounting the inductor assembly 14 within the transmission 12, the inductor assembly 14 may be directly cooled by transmission fluid which allows for a simplified design.

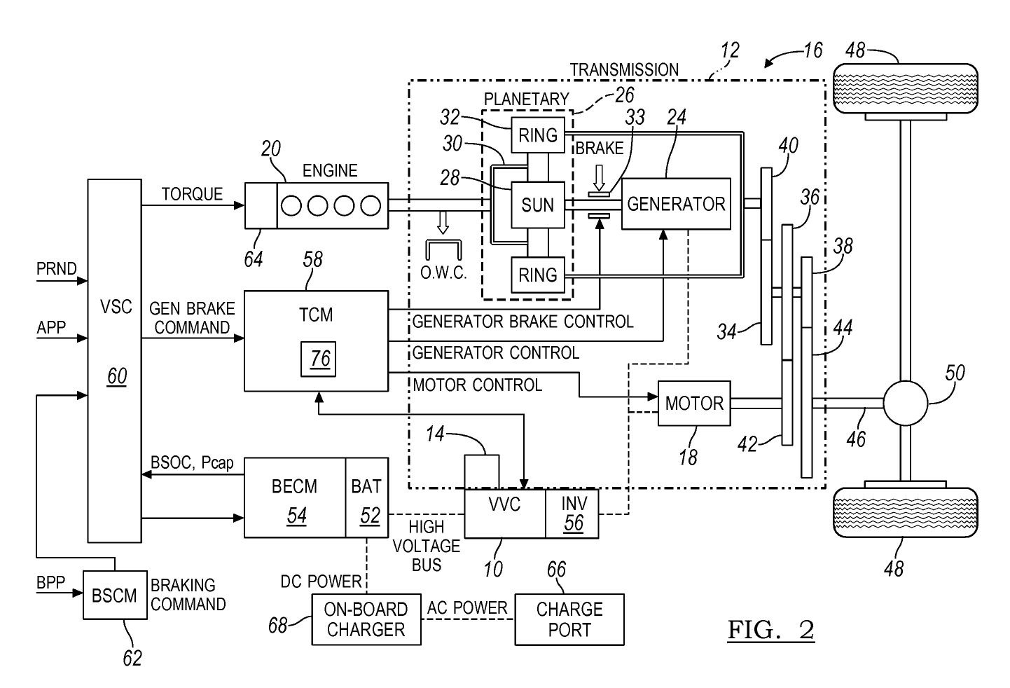

Referring to FIG. 2, the transmission 12 is depicted within a plug-in hybrid electric vehicle (PHEV) 16, which is an electric vehicle propelled by an electric machine 18 with assistance from an internal combustion engine 20 and connectable to an external power grid. The electric machine 18 is an AC electric motor according to one or more embodiments, and depicted as the “motor” 18 in FIG. 1. The electric machine 18 receives electrical power and provides drive torque for vehicle propulsion. The electric machine 18 also functions as a generator for converting mechanical power into electrical power through regenerative braking.

The transmission 12 has a power-split configuration, according to one or more embodiments. The transmission 12 includes the first electric machine 18 and a second electric machine 24. The second electric machine 24 is an AC electric motor according to one or more embodiments, and depicted as the “generator” 24 in FIG. 1. Like the first electric machine 18, the second electric machine 24 receives electrical power and provides output torque. The second electric machine 24 also functions as a generator for converting mechanical power into electrical power and optimizing power flow through the transmission 12.

The transmission 12 includes a planetary gear unit 26, which includes a sun gear 28, a planet carrier 30 and a ring gear 32. The sun gear 28 is connected to an output shaft of the second electric machine 24 for receiving generator torque. The planet carrier 30 is connected to an output shaft of the engine 20 for receiving engine torque. The planetary gear unit 26 combines the generator torque and the engine torque and provides a combined output torque about the ring gear 32. The planetary gear unit 26 functions as a continuously variable transmission, without any fixed or “step” ratios.

The transmission 12 also includes a one-way clutch (O.W.C.) and a generator brake 33, according to one or more embodiments. The O.W.C. is coupled to the output shaft of the engine 20 to only allow the output shaft to rotate in one direction. The O.W.C. prevents the transmission 12 from back-driving the engine 20. The generator brake 33 is coupled to the output shaft of the second electric machine 24. The generator brake 33 may be activated to “brake” or prevent rotation of the output shaft of the second electric machine 24 and of the sun gear 28. In other embodiments, the O.W.C. and the generator brake 33 are eliminated, and replaced by control strategies for the engine 20 and the second electric machine 24.

The transmission 12 includes a countershaft having intermediate gears including a first gear 34, a second gear 36 and a third gear 38. A planetary output gear 40 is connected to the ring gear 32. The planetary output gear 40 meshes with the first gear 34 for transferring torque between the planetary gear unit 26 and the countershaft. An output gear 42 is connected to an output shaft of the first electric machine 18. The output gear 42 meshes with the second gear 36 for transferring torque between the first electric machine 18 and the countershaft. A transmission output gear 44 is connected to a driveshaft 46. The driveshaft 46 is coupled to a pair of driven wheels 48 through a differential 50. The transmission output gear 44 meshes with the third gear 38 for transferring torque between the transmission 12 and the driven wheels 48.

The vehicle 16 includes an energy storage device, such as a battery 52 for storing electrical energy. The battery 52 is a high voltage battery that is capable of outputting electrical power to operate the first electric machine 18 and the second electric machine 24. The battery 52 also receives electrical power from the first electric machine 18 and the second electric machine 24 when they are operating as generators. The battery 52 is a battery pack made up of several battery modules (not shown), where each battery module contains a plurality of battery cells (not shown). Other embodiments of the vehicle 16 contemplate different types of energy storage devices, such as capacitors and fuel cells (not shown) that supplement or replace the battery 52. A high voltage bus electrically connects the battery 52 to the first electric machine 18 and to the second electric machine 24.

The vehicle includes a battery energy control module (BECM) 54 for controlling the battery 52. The BECM 54 receives input that is indicative of vehicle conditions and battery conditions, such as battery temperature, voltage and current. The BECM 54 calculates and estimates battery parameters, such as battery state of charge and the battery power capability. The BECM 54 provides output (BSOC, P_{cap}) that is indicative of the BSOC and the battery power capability to other vehicle systems and controllers.

The transmission 12 includes the VVC 10 and an inverter 56. The VVC 10 and the inverter 56 are electrically connected between the main battery 52 and the first electric machine 18; and between the battery 52 and the second electric machine 24. The VVC 10 “boosts” or increases the voltage potential of the electrical power provided by the battery 52. The VVC 10 also “bucks” or decreases the voltage potential of the electrical power provided by the battery 52, according to one or more embodiments. The inverter 56 inverts the DC power supplied by the main battery 52 (through the VVC 10) to AC power for operating the electric machines 18, 24. The inverter 56 also rectifies AC power provided by the electric machines 18, 24, to DC for charging the main battery 52. Other embodiments of the transmission 12 include multiple inverters (not shown), such as one invertor associated with each electric machine 18, 24.

The transmission 12 includes a transmission control module (TCM) 58 for controlling the electric machines 18, 24, the VVC 10 and the inverter 56. The TCM 58 is configured to monitor, among other things, the position, speed, and power consumption of the electric machines 18, 24. The TCM 58 also monitors electrical parameters (e.g., voltage and current) at various locations within the VVC 10 and the inverter 56. The TCM 58 provides output signals corresponding to this information to other vehicle systems.

The vehicle 16 includes a vehicle system controller (VSC) 60 that communicates with other vehicle systems and controllers for coordinating their function. Although it is shown as a single controller, the VSC 60 may include multiple controllers that may be used to control multiple vehicle systems according to an overall vehicle control logic, or software.

The vehicle controllers, including the VSC 60 and the TCM 58 generally includes any number of microprocessors, ASICs, ICs, memory (e.g., FLASH, ROM, RAM, EPROM and/or EEPROM) and software code to co-act with one another to perform a series of operations. The controllers also include predetermined data, or “look up tables” that are based on calculations and test data and stored within the memory. The VSC 60 communicates with other vehicle systems and controllers (e.g., the BECM 54 and the TCM 58) over one or more wired or wireless vehicle connections using common bus protocols (e.g., CAN and LIN). The VSC 60 receives input (PRND) that represents a current position of the transmission 12 (e.g., park, reverse, neutral or drive). The VSC 60 also receives input (APP) that represents an accelerator pedal position. The VSC 60 provides output that represents a desired wheel torque, desired engine speed, and generator brake command to the TCM 58; and contactor control to the BECM 54.

The vehicle 16 includes a braking system (not shown) which includes a brake pedal, a booster, a master cylinder, as well as mechanical connections to the driven wheels 48, to effect friction braking. The braking system also includes position sensors, pressure sensors, or some combination thereof for providing information such as brake pedal position (BPP) that corresponds to a driver request for brake torque. The braking system also includes a brake system control module (BSCM) 62 that communicates with the VSC 60 to coordinate regenerative braking and friction braking. The BSCM 62 provides a regenerative braking command to the VSC 60, according to one embodiment.

The vehicle 16 includes an engine control module (ECM) 64 for controlling the engine 20. The VSC 60 provides output (desired engine torque) to the ECM 64 that is based on a number of input signals including APP, and corresponds to a driver's request for vehicle propulsion.

The vehicle 16 is configured as a plug-in hybrid electric vehicle (PHEV) according to one or more embodiments. The battery 52 periodically receives AC energy from an external power supply or grid, via a charge port 66. The vehicle 16 also includes an on-board charger 68, which receives the AC energy from the charge port 66. The charger 68 is an AC/DC converter which converts the received AC energy into DC energy suitable for charging the battery 52. In turn, the charger 68 supplies the DC energy to the battery 52 during recharging.

Although illustrated and described in the context of a PHEV 16, it is understood that embodiments of the VVC 10 may be implemented on other types of electric vehicles, such as a HEV or a BEV.

With reference to FIG. 3, the VVC 10 includes a first switching unit 78 and a second switching unit 80 for boosting the input voltage (V_{bat}) to provide output voltage (V_{dc}). The first switching unit 78 includes a first transistor 82 connected in parallel to a first diode 84, but with their polarities switched (anti-parallel). The second switching unit 80 includes a second transistor 86 connected anti-parallel to a second diode 88. Each transistor 82, 86 may be any type of controllable switch (e.g., an insulated gate bipolar transistor (IGBT) or field-effect transistor (FET)). Additionally, each transistor 82, 86 is individually controlled by the TCM 58. The inductor assembly 14 is depicted as an input inductor that is connected in series between the main battery 52 and the switching units 78, 80. The inductor 14 generates magnetic flux when a current is supplied. When the current flowing through the inductor 14 changes, a time-varying magnetic field is created, and a voltage is induced. Other embodiments of the VVC 10 include different circuit configurations (e.g., more than two switches).

Referring back to FIG. 1, the transmission 12 includes a transmission housing 90, which is illustrated without a cover to show internal components. As described above, the engine 20, the motor 18 and the generator 24 include output gears that mesh with corresponding gears of the planetary gear unit 26. These mechanical connections occur within an internal chamber 92 of the transmission housing 90. A power electronics housing 94 is mounted to an external surface of the transmission 12. The inverter 56 and the TCM 58 are mounted within the power electronics housing 94. The VVC 10 includes components (e.g., the switches 78, 80 and diodes 84, 88 shown in FIG. 3) that are mounted within the power electronics housing 94 and the inductor assembly 14 which is mounted within the chamber 92 of the transmission housing 90.

The transmission 12 includes fluid 96 such as oil, for lubricating and cooling the gears located within the transmission chamber 92 (e.g., the intermediate gears 34, 36, 38). The transmission chamber 92 is sealed to retain the fluid 96. The transmission 12 also includes pumps and conduits (not shown) for circulating the fluid 96. The transmission 12 may include nozzles (not shown) for directly spraying the fluid 96 on components within the housing 90. Additionally, rotating components (e.g., the second gear 36) may splash fluid 96 on other components. Further, the fluid 96 accumulates within a lower portion of the chamber 92. Therefore components may be mounted to a lower portion of the housing 90, such that they are immersed in the fluid 96. The inductor assembly 14 is mounted within the transmission chamber 92 such that it is directly cooled by the transmission fluid 96 through spraying, splashing and/or immersion.

FIG. 4 illustrates an inductor assembly 100 that is configured for indirect cooling according to an existing method. Such an inductor assembly 100 is mounted external of the transmission housing 90 (e.g., within the power electronics housing 94 of FIG. 1). The inductor assembly 100 includes a conductor 110 that is wrapped around a magnetic core 112. The magnetic core 112 includes a plurality of core elements that are spaced apart to define air gaps 114. Ceramic spacers may be placed between the core elements to maintain the air gaps 114. The inductor assembly 100 is encased inside an inductor housing 116 (e.g., an Aluminum housing) and empty space around the inductor assembly 100 is filled with a thermally conductive, electrically insulating potting compound 118. The inductor housing 116 is clamped to a cold plate 120 and thermal grease 122 is applied between the inductor housing 116 and the cold plate 120. A passage 124 is formed through the cold plate 120. Cold fluid or coolant (e.g., 50% water and 50% ethylene glycol) flows through the passage 124. Heat transfers by conduction from the conductor 110 and the core 112 to the potting compound 118 and then to housing 116, thermal grease 122 and finally into the cold plate 120. Heat from the cold plate 120 transfers into the coolant flowing through the passage 124 by convection. Additionally the cold plate 120 may include fins 126 for transferring heat into surrounding air by convection.

The thermal resistance of the heat transfer path from the conductor 110 to the coolant flowing through the passage 124 of the cold plate 120 is high. The thermal grease 122, the potting compound 118 and the cold plate 120 contribute significantly to this resistance. As a result, the thermal performance of this potted inductor assembly 100 is limited and the temperature of the inductor assembly 100 at various locations increases and may exceed predetermined temperature limits at high electrical power loads. In one or more embodiments, a controller (e.g., the TCM of FIG. 1) may limit the performance of the inductor assembly 100 if temperatures of the inductor assembly 100 exceed such predetermined limits.

The temperature of the inductor assembly 100 depends on the amount of current flowing through the conductor 110 and the voltage potential across the conductor 110. Recent trends in electric vehicles include higher current capability of the inductor. For example, increased battery power for the extended electric range in PHEVs and reduced battery cells for the same power in HEVs result in increased inductor current rating in electric vehicles. Additionally, reduced battery voltage also leads to an increase in the inductor ac losses due to a higher magnitude of high frequency ripple current. Therefore, due to additional heat generation, the temperature of the inductor assembly 100 will generally increase and if heat is not dissipated, the inductor temperature may exceed predetermined limits. One solution is to increase the cross-sectional area of the conductor coil to reduce inductor loss and also improve heat dissipation (due to more surface area). However, such changes will increase the overall size of the inductor assembly. A larger inductor assembly may be difficult to package in all vehicle applications, and larger components affect vehicle fuel economy and cost.

Rather than increase the size of the inductor assembly 100 to improve the inductor thermal performance and thermal capacity, the inductor assembly 100 may be mounted within the transmission chamber 92 and directly cooled using transmission fluid 96 as described with reference to FIG. 1. The transmission fluid 96 is an electrical insulator which can be used in direct contact with electrical components (e.g., the conductor 110 and the core 112). However, excess components associated with the inductor assembly 100 may be removed if the assembly 100 is subjected to such direct cooling. For example, the potting compound 118 and the aluminum housing 116 may be removed. However, the potting compound 118 and the housing 116 support the conductor 110 and the core 112. Additionally, vibration is more severe inside of the transmission 12, than outside. Therefore the overall structure of the inductor assembly 100 is revised in order to remove the potting compound 118 and housing 116 and mount the assembly inside of the transmission 12.

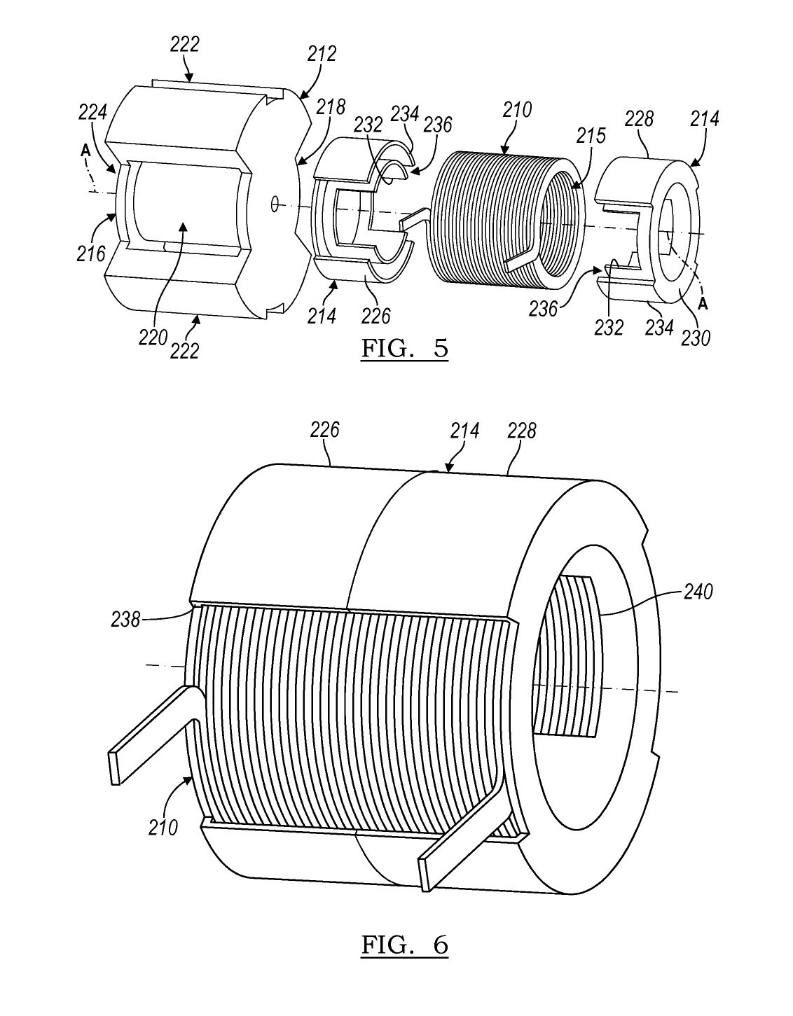

FIG. 5 illustrates an exploded view of the inductor assembly 14, according to one or more embodiments. The inductor assembly 14 is mounted within the transmission and directly cooled by transmission fluid. The inductor assembly 14 includes a conductor 210, a core 212 and an insulator 214 that are integrally formed with each other.

The conductor 210 is formed of a conductive material, such as copper, and wound into a helical coil that defines a cylindrical cavity 215 about a longitudinal axis A-A. The coil is formed using a rectangular (or flat) type conductive wire by an edgewise process, according to one or more embodiments. An input and output lead extend from the conductor 210 and connect to components that are mounted external to the transmission 12 (e.g., the battery 52 and the switches 78, 80 as shown in FIGS. 2 and 3).

The core 212 is formed of a magnetic material, such as an iron silicon alloy powder. The core 212 is formed as a unitary (one-piece) structure around the conductor 210. The core 212 includes a first end 216 and a second end 218 that are connected by a post 220. The post 220 has a cylindrical shape and is centered about the longitudinal axis A-A, according to the illustrated embodiment. The first end 216 and the second end 218 each extend radially outward from opposing ends of the post 220.

The core 212 also includes two projections 222 that extend between the ends 216, 218 according to one or more embodiment. The projections 222 are angularly spaced apart from each other to define openings 224 between adjacent projections. The core 212 includes two projections 222 that are formed diametrically opposite each other relative to the axis A-A, according to the illustrated embodiment. Other embodiments of the inductor assembly 14 envision a core 212 having more than two projections 222 which form more than two openings (not shown).

The insulator 214 is formed of an electrically insulating polymeric material, such as Polyphenylene sulfide (PPS). The insulator 214 includes a first bobbin 226 and a second bobbin 228 that are oriented toward each other along the longitudinal axis A-A. Each bobbin 226, 228 includes a base 230 with inner wall 232 and an outer wall 234 extending longitudinally from the base 230. The base 230 is formed in an annular shape according to the illustrated embodiment. The inner and outer walls 232, 234 are spaced radially apart from each other to collectively form a tubular cavity 236 for receiving the conductor 210.

Referring to FIG. 6, the insulator 214 is disposed over a portion of the conductor 210. Each bobbin 226, 228 includes a pair of outer apertures 238 that are formed through the outer wall 234 for exposing a portion of the conductor 210. Each bobbin 226, 228 may also include a pair of inner apertures 240 formed through the inner wall 232. The inner apertures 240 are aligned with the outer apertures 238. Other embodiments of the inductor assembly 14 contemplate an insulator formed of paper (e.g., Nomex® Paper), or a coating applied to the conductor (not shown).

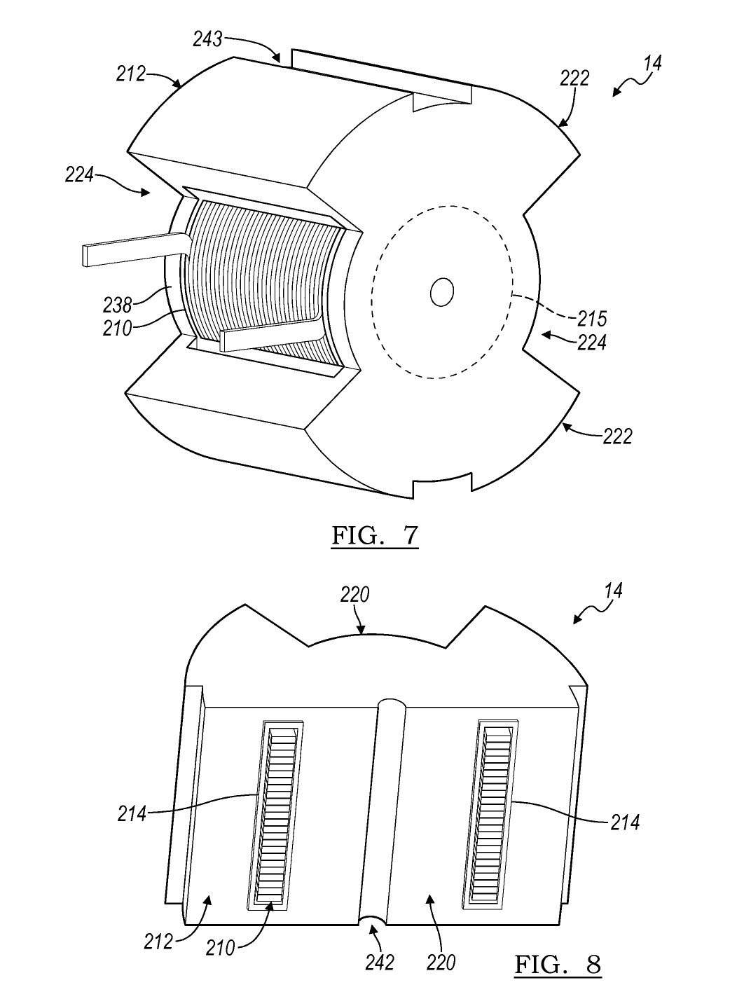

Referring to FIGS. 7 and 8, the conductor 210 is externally accessible through the openings 224 formed in the core 212. The projections 222 are spaced radially outward of the conductor 210 and angularly spaced apart from each other to define the openings 224. The thermal performance of the inductor assembly 14 improves with larger openings 224 since more surface area of the conductor 210 is exposed. The openings 224 formed in the core 212 align with the outer apertures 238 formed through the outer wall 234 of the insulator 214 and span a substantial portion of a height of the conductor coil.

The inductor assembly 14 may be mounted to the transmission housing a fastener (not shown) that extends through the core 212. The core 212 includes an axially extending aperture 242 formed through the post 220, according to one embodiment. The post 220 extends through the cylindrical cavity 215 defined by the conductor 210. The aperture 242 is sized for receiving a fastener (not shown) for mounting the inductor assembly 14 to the transmission housing. In other embodiments, the inductor assembly 14 includes a solid post 220 with an external bracket (not shown) for mounting to the transmission housing. The bracket wraps around a portion of the inductor assembly 14, without covering the openings 224. The core 212 includes grooves 243 that are formed into an outer surface, according to one or more embodiments. Such grooves 243 may engage the mounting bracket (not shown) and provide an anti-rotation feature.

FIG. 8 illustrates a cross-section view of the inductor assembly 14 taken along section line 8-8 of FIG. 7. The insulator 214 physically separates the conductor 210 from the core 212 and provides electrical insulation. The distributed air gap inside the core can be adjusted by the ratio of insulation resin material to magnetic powder to obtain the required electrical performance (inductance profile for dc current). Eliminating the discreet air gap pieces in this design simplifies the manufacturing process.

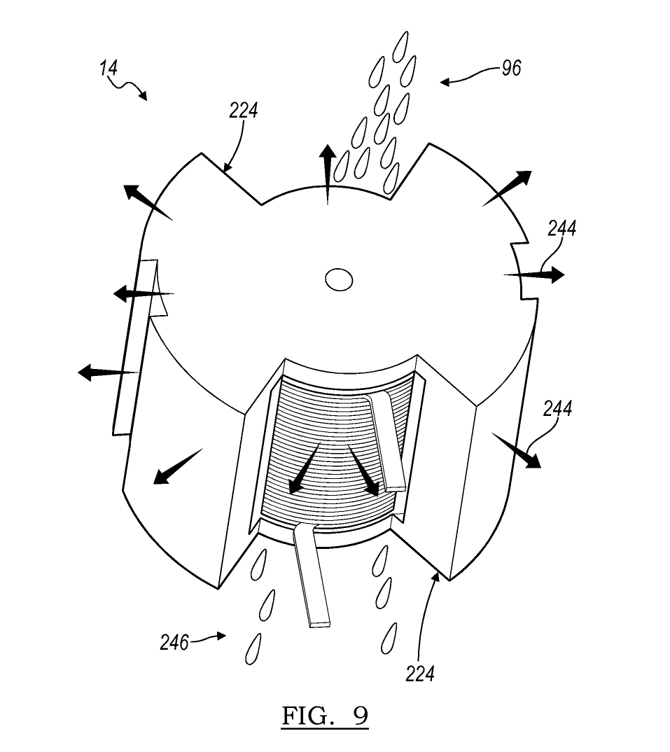

Referring to FIG. 9 the inductor assembly 14 is configured for direct cooling by the transmission fluid 96. The inductor assembly 14 produces a significant power loss (up to 1 kW) at variant converter power levels. The conductor 210 may be formed of a conductive material such as copper or aluminum. When current having a high frequency component (or “ripple”) flows through the copper coil, a significant copper loss and associated magnetic flux ripple is generated which results in power loss. Power loss may be dissipated as heat. High heat loads may damage the inductor assembly 14. Therefore the inductor assembly 14 is cooled using the transmission fluid 96.

The inductor assembly 14 is mounted within the transmission chamber 92 such that it is directly cooled by the transmission fluid 96 that sprays off of gears (e.g., the second intermediate gear 36 shown in FIG. 1). The inductor assembly 14 generates heat as current flows through the conductor 210. Heat flows radially away from the inductor assembly 14, as represented by numeral 244 in FIG. 9. The transmission fluid 96 enters the inductor assembly 14 through one or more of the openings 224. Heat transfers by convection from the conductor 210 and core 212 to the fluid 96, as the fluid 96 flows over the inductor assembly 14. The heated fluid 244 then exits the inductor assembly 14 through one or more of the openings 224.

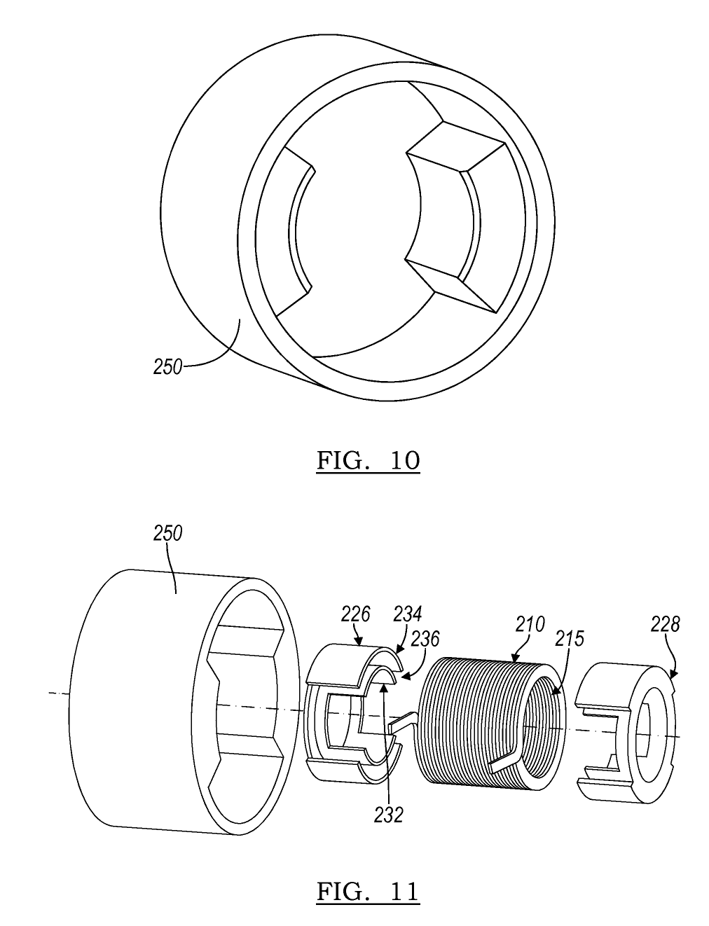

Referring to FIGS. 9-11, a method of integrally forming the inductor assembly 14 is illustrated in accordance with one or more embodiments. The conductor 210 is formed of a flat type conductive wire, and then wound into a coil that defines a cylindrical cavity 215. The bobbins 226, 228 are formed (e.g., by molding) with inner walls 232 and outer walls 234 that are radially spaced apart from each other to define a tubular cavity 236. The bobbins 226, 228 are then translated toward each other such that the coil is received within the tubular cavity 236. The bobbins 226, 228 collectively form an insulator 214 which is disposed over a portion of an inner surface and an outer surface of the coil. The conductor 210 and the insulator 214 are placed into a die 250. The die 250 is filled with a resin mixture of magnetic powder and resin (not shown). The resin mixture solidifies to form the core 212 over the conductor 210 and the insulator 214 as an integrated inductor assembly 14.

As such, the inductor assembly 14 provides advantages over existing inductor assemblies by facilitating direct cooling of the conductor 210 and core 212. Further the inductor assembly 14 provides a simplified structure without potting compound or additional housings and cold plates that add inefficiencies to heat dissipation. Additionally, this structure simplifies the mounting and packaging of the inductor assembly 14 inside of the transmission and minimizes Electromagnetic Interference (EMI) and the leakage inductance by substantially surrounding the conductor 210 with the magnetic core 212.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle comprising:
a transmission defining a chamber;
a coil mounted within the chamber and defining a cavity; and
a core having at least two projections spaced radially outward of the coil and angularly spaced apart from each other to define openings therebetween and first and second ends interconnected by a post extending through the cavity.

2. The vehicle of claim 1 wherein the transmission further comprises fluid disposed within the chamber, and wherein the fluid flows through the openings in the core and over the coil for facilitating heat transfer from the coil by convection.

3. The vehicle of claim 2 further comprising a rotatable element coupled to the transmission and disposed within the chamber, the rotatable element being in contact with the fluid for displacing the fluid onto at least one of the core and the coil during rotation.

4. The vehicle of claim 3 wherein the rotatable element further comprises an intermediate gear, the intermediate gear engaging an output gear of an electric machine for coupling the electric machine to a driveshaft.

5. The vehicle of claim 1 wherein the vehicle further comprises an inductor assembly, the inductor assembly having the coil, the core and an insulator disposed on a portion of the coil for physically separating the coil from the core.

6. The vehicle of claim 5 further comprising:
a converter configured to adjust a voltage level of energy transmitted between an energy storage device and an electric machine, the converter comprising the inductor assembly and at least two switches, wherein the switches are mounted external to the transmission.

7. The vehicle of claim 1 wherein the post is formed in a generally cylindrical shape and centered about a longitudinal axis, and wherein the projections further comprise two projections spaced diametrically opposite each other about the longitudinal axis.

8. An integrated inductor assembly comprising:
a coil defining a cavity; and
a core having at least two projections spaced radially outward of the coil and interconnected by first and second ends, the projections being angularly spaced apart from each other to define openings between adjacent projections, and a post extending through the cavity between the first and second ends;
wherein the core is formed as a unitary structure around the coil.

9. The integrated inductor assembly of claim 8 wherein the projections are sized for receiving fluid through the openings such that the fluid flows over a portion of the coil for facilitating heat transfer.

10. The integrated inductor assembly of claim 8 further comprising:
an insulator disposed on a portion of the coil to physically separate the coil from the core.

11. The integrated inductor assembly of claim 10 wherein the insulator is formed in a generally tubular shape with an inner wall extending through the cavity between the post and the coil, and an outer wall extending between the projections and the coil.

12. The integrated inductor assembly of claim 11 wherein the insulator includes at least two apertures formed through the outer wall, the apertures being aligned with the openings formed through the core for facilitating external access to the coil.

13. The integrated inductor assembly of claim 10 wherein the insulator further comprises a pair of bobbins, each bobbin comprising:
a base having an annular shape; and
an inner wall and an outer wall each extending longitudinally from the base and radially spaced apart from each other;
wherein the bobbins are oriented toward each other to collectively form a tubular cavity between the inner walls and the outer walls for receiving the coil.

14. The integrated inductor assembly of claim 10 wherein the post further comprises a solid post formed of insulation material and magnetic material to provide a distributed air gap.

15. A voltage converter comprising:
a coil defining a cavity and mounted within a chamber of a transmission;
a core having a post extending through the cavity and at least two projections spaced radially outward of the coil and angularly spaced apart from each other to define openings therebetween; and
at least two switches mounted external to the transmission and in communication with the coil.

16. The voltage converter of claim 15 wherein the coil defines a cylindrical cavity.

17. The voltage converter of claim 15 wherein the post is formed with an axially extending aperture formed through for receiving a fastener for mounting the core to the transmission.

18. The voltage converter of claim 15 wherein the openings are sized for receiving fluid, and wherein the fluid flows through the openings and over the coil for facilitating heat transfer.

19. The voltage converter of claim 15 further comprising an inductor assembly, the inductor assembly having the coil, the core and an insulator disposed on a portion of the coil for physically separating the coil from the core.

20. The voltage converter of claim 19 wherein the core, the coil and the insulator are integrally formed with each other.
